(19) United States
(12) Patent Application Publication
(10) Pub. No.: US 2010/0149122 A1
(43) Pub. Date: Jun. 17, 2010

(54) Touch Panel with Multi-Touch Function and Method for Detecting Multi-Touch Thereof

(75) Inventor: Hung-Yi Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/623,628

(22) Filed: Nov. 23, 2009

(30) Foreign Application Priority Data
Dec. 12, 2008 (TW) 97148652

(51) Int. Cl. G06F 3/041

(52) U.S. Cl. 345/173

(57) ABSTRACT

A touch panel with a multi-touch function and a method for detecting a multi-touch thereof are provided. The touch panel includes transparent conductive substrate, a transparent conductive film, first conducting wires, second conducting wires and a main detecting module. The transparent conductive film is disposed on the transparent conductive substrate. The two first conducting wires and second conducting wires are disposed at four corresponding sides of the transparent conductive substrate, to provide a constant voltage. A dividing voltage corresponding to the constant voltage is generated while the transparent conductive film is touched to conduct the transparent conductive film and transparent conductive substrate. The main detecting module obtains a touch resistance value based on the constant voltage and the dividing voltage, compares the touch resistance value with a preset resistance value and determines that a multi-touch mode is executed when the touch resistance value is less than the preset resistance value.

### CROSS-REFERENCES TO RELATED APPLICATIONS

This non-provisional application claims priority under 35 U.S.C. §119(a) on Patent Application No. 97148652 filed in Taiwan, R.O.C. on 2008 Dec. 12, the entire contents of which are hereby incorporated by reference.

### BACKGROUND OF THE INVENTION

1. Field of the Invention

The invention relates to a touch panel and a detecting method thereof and, more particularly, to a touch panel having a multi-touch function and a method for detecting the multi-touch.

2. Description of the Related Art

With the progress of science and technology, a touch panel is used more widely. In the earlier days, the touch panel is only used by the army or in some particular cases, and nowadays it may be used in many kinds of electronic products to input information. The touch panel is more intuitive and human-based than the conventional input devices, and thus the touch panel gradually replaces the conventional keyboard and mouse to be the most popular input interface recently.

With the improvement of the functions in electronic products, the number of input types increases therewith. Thus, the touch mode of the touch panel gradually becomes a multi-touch from a single-touch. In the conventional technique, most touch panels use a capacitive touch panel or an additional sensor, such as an infrared ray sensor or other technique to achieve the multi-touch function. Besides, a plurality of charge coupled device (CCD) cameras inside a main unit may work with a digital light processing (DLP) projector to distinguish multi-touch signals.

However, compared with the resistive touch panel, the capacitive touch panel, the additional sensor, the camera or other related technique, all may increase the cost. Since the resistive touch panel has a low cost, it has the highest market occupancy. The resistive touch panel may be divided into four-wire, five-wire, eight-wire touch panels and so on, and the four-wire touch panel has the lowest cost. However, the conventional four-wire touch panel only may achieve a single-touch, and if a multi-touch is performed, the four-wire touch panel would fail to identify the multi-touch, and it is also unable to control the cursor to execute relate actions.

### BRIEF SUMMARY OF THE INVENTION

The invention provides a touch panel having a multi-touch function which includes transparent conductive substrate, a transparent conductive film, first conducting wires, second conducting wires and a main detecting module. The transparent conductive film is disposed on the transparent conductive substrate. The two first conducting wires are disposed at two corresponding sides of the transparent conductive substrate for providing a constant voltage. The two second conducting wires are disposed at two corresponding sides of the transparent conductive films, respectively, and the second conducting wires are vertical to the first conducting wires for providing the constant voltage. When the transparent conductive film is touched to conduct the transparent conductive film and the transparent conductive substrate, a dividing voltage corresponding to the constant voltage is generated. The main detecting module obtains the touch resistance value according to the constant voltage and the dividing voltage, compares the touch resistance value with the preset resistance value and determines that the multi-touch mode is executed when the touch resistance value is less than the preset resistance value.

The invention also provides a method for detecting a multi-touch used in the touch panel, which includes the steps as follows. The touch panel receives the constant voltage. When the touch panel is touched, a dividing voltage corresponding to the constant voltage is generated. The touch resistance value is obtained according to the constant voltage and the dividing voltage. The touch resistance value is compared with the preset resistance value, and when the touch resistance value is less than the preset resistance value, it is determined that the touch panel executes the multi-touch mode.

In the touch panel or the method provided in the invention, the touch panel having a low cost has the multi-touch function. Thus, the capacitive touch panel having a high cost is not needed, and an additional sensor or a camera is also not needed. Thus, the multi-touch function is achieved, and the cost is saved greatly.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a touch panel having the multi-touch function in the first embodiment of the invention;

FIG. 2A is a first circuit diagram showing the touch panel having the multi-touch function;

FIG. 2B is a second circuit diagram showing the touch panel having the multi-touch function;

FIG. 2C is a third circuit diagram showing the touch panel having the multi-touch function;

FIG. 2D is a fourth circuit diagram showing the touch panel having the multi-touch function;

FIG. 3A is a schematic diagram showing the touch panel having the multi-touch function in the second embodiment;

FIG. 3B is a fifth circuit diagram showing the touch panel having the multi-touch function;

FIG. 3C is a sixth circuit diagram showing the touch panel having the multi-touch function;

FIG. 4 is a schematic diagram showing the touch panel having the multi-touch function in the third embodiment;

FIG. 5A is a schematic diagram showing that the image in the multi-touch mode is rotated;

FIG. 5B is a schematic diagram showing that the image in the multi-touch mode is zoomed;

FIG. 5C is a first schematic diagram showing that the scroll bar is moved in the multi-touch mode;

FIG. 5D is a second schematic diagram showing that the scroll bar is moved in the multi-touch mode; and

FIG. 6 is a flow chart showing the method for detecting the multi-touch.

### DETAILED DESCRIPTION OF THE EMBODIMENTS

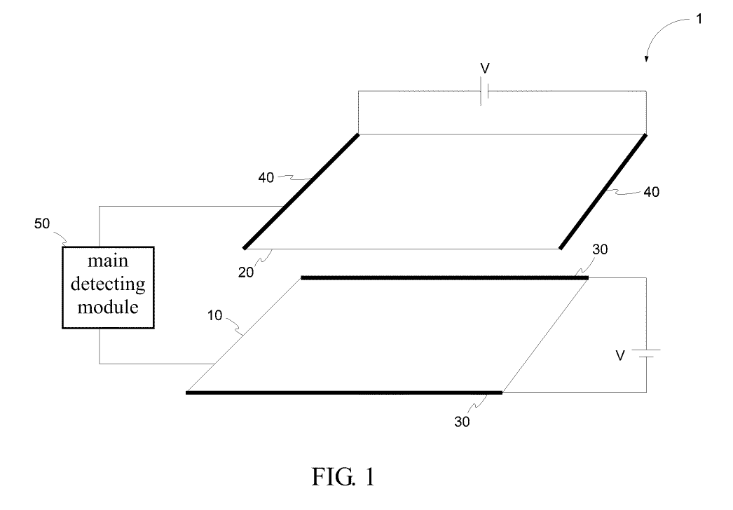

FIG. 1 is a schematic diagram showing a touch panel having a multi-touch function in a first embodiment. As shown in FIG. 1, the touch panel 1 having the multi-touch function provided in the invention includes transparent conductive substrate 10, a transparent conductive film 20, first conducting wires 30, second conducting wires 40 and a main detecting module 50.

The transparent conductive substrate 10 is a transparent glass substrate. The transparent conductive film 20 is disposed corresponding to the transparent conductive substrate 10. The transparent conductive film 20 can be an Indium Tin Oxide (ITO) film or an Al-doped ZnO (AZO) film. As shown in FIG. 1, the transparent conductive film 20 is disposed above the transparent conductive substrate 10. Thus, a dot spacer (not shown) may be disposed between the transparent conductive substrate 10 and the transparent conductive film 20 to separate the two conducting materials. This is to prevent a short circuit without touching the touch panel 1 and avoid operating accidentally. In addition, the transparent conductive substrate 10 and the transparent conductive film 20 are drawn separately to facilitate the illustration. In actual application, they are integrated.

The number of the first conducting wires 30 may be two, and they are disposed at two corresponding sides of the transparent conductive substrate 10 and provide a constant voltage. In an embodiment, the two first conducting wires 30 provide a zero volt voltage and a five volt voltage respectively; to make the transparent conductive substrate 10 generate an even electric field.

The number of the second conducting wires 40 may be two, and they are disposed at two corresponding sides of the transparent conductive film 20. The second conducting wires 40 and the first conducting wires 30 are vertical to each other, and a constant voltage is provided via the second conducting wires 40. In an embodiment, the two second conducting wires provide a zero volt voltage and a five volt voltage respectively, to make the transparent conductive film 20 generate an even electric field. From the description for the disposition of the components above, it may be determined that the touch panel 1 provided in the invention is a four-wire resistive touch panel.

When the user touches the transparent conductive film 20 by a finger, a pen or others, the transparent conductive film 20 and the transparent conductive substrate 10 contact with each other to be conductive. At that moment, a dividing voltage corresponding to the constant voltage is generated.

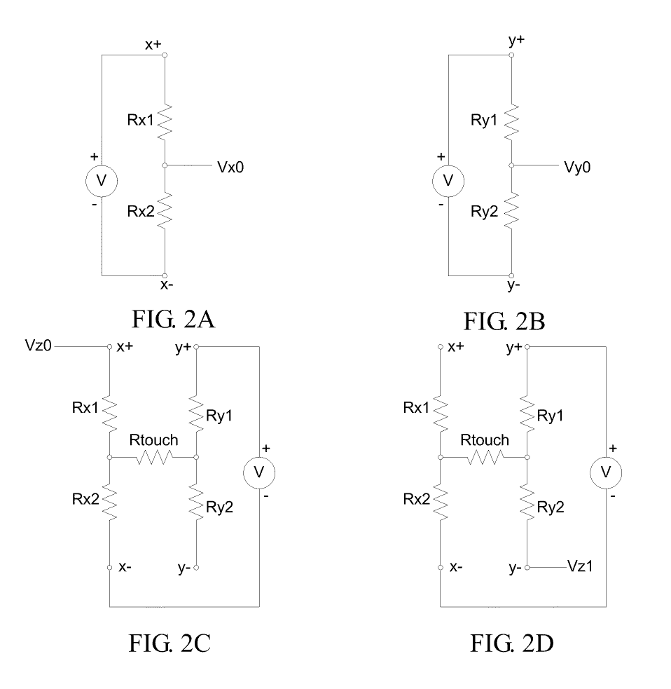

FIG. 2A and FIG. 2B are a first circuit diagram and a second circuit diagram showing the touch panel having the multi-touch function, respectively. As shown in FIG. 2A and FIG. 2B, the upper transparent conductive film 20 and the lower transparent conductive substrate 10 correspond to the X-axis coordinate and the Y-axis coordinate, respectively. Two points determines a correct position, and when the finger, the pen or other medium is used to touch the touch panel 1, the upper transparent conductive film 20 and the lower transparent conductive substrate 10 contact with each other, and they form a short circuit to generate a voltage drop. As shown in FIG. 2A, it is a circuit diagram showing the X-axis voltage (Vx). Based on the voltage division theorem, an X-axis voltage point Vx is obtained on the transparent conductive film 20. Similarly, as shown in FIG. 2B, it is a circuit diagram showing the Y-axis voltage Vy. Based on the voltage division theorem, a Y-axis voltage point Vy is obtained on the transparent conductive substrate 10. When the voltages Vx and Vy are obtained, the voltage value is converted to a coordinate value, and the coordinate information of the touch point is obtained.

As shown in FIG. 1, the main detecting module 50 obtains the touch resistance value according to the constant voltage provided by the first and second conducting wires 30 and 40 and the dividing voltage obtained after the touch panel is touched. Then, the touch resistance value is compared with a preset resistance value. When the touch resistance value is less than the preset resistance value, the multi-touch mode is determined to be executed. The process of obtaining the touch resistance value is shown hereinbelow, as shown in FIG. 2A to FIG. 2D.

$${V}_{x 0} = \frac{{Rx}_{2}}{{Rx}_{1} + {Rx}_{2}} \times V$$

$${Vz}_{{ }_{0}} = \frac{{Rx}_{2}}{{Ry}_{1} + {R}_{touch} + {Rx}_{2}} \times V$$

$${Vz}_{1} = \frac{{R}_{touch} + {Rx}_{2}}{{Ry}_{1} + {R}_{touch} + {Rx}_{2}} \times V$$

$$\begin{matrix}{V}_{x 0} \times ( {Vz}_{1} / {Vz}_{0} - 1 ) = \frac{{Rx}_{2}}{{Rx}_{1} + {Rx}_{2}} \times V \times ( \frac{{R}_{touch} + {Rx}_{2}}{{Rx}_{2}} - 1 ) \\ = \frac{{Rx}_{2}}{{Rx}_{1} + {Rx}_{2}} \times V \times ( \frac{{R}_{touch}}{{Rx}_{2}} ) \\ = {R}_{touch} \times \frac{V}{{Rx}_{1} + {Rx}_{2}}\end{matrix}$$

In the above formulas, since V/(Rx1+Rx2) is a constant, from the derivation above, the R_{touch} equals to Vx*(Vz1/Vz0−1) multiplied by a constant, and the constant relates to the characteristic of the touch panel. The R_{touch} is the touch resistance, the V is a constant voltage, the Vxo is the X-axis dividing voltage, the Vzo and Vz1 are the voltages of the two ends of the touch resistance obtained by combining the X-axis dividing voltage circuit in FIG. 2A and the Y-axis dividing voltage circuit in FIG. 2B with FIG. 2C and FIG. 2D, respectively.

From experimental data, when only one point in the touch panel 1 is touched, the detected touch resistance value relates to the pressing power. The larger the power is, the less the touch resistance value is. The experimental data shows that the touch resistance value corresponding to the single-touch is about 170 at least.

In another aspect, when the touch panel 1 is in the multi-touch mode, supposing that there are two touch points, the following experiment is performed. Two fingers make change diagonally, and that is, the two fingers moves in a diagonal mode. When the touch resistance value is measured, it is detected that when the two fingers touch the touch panel 1, the touch resistance value is less than 50. Taking another type of multi-touch to perform the experiment, the two fingers move vertically, and it is detected that the resistance value is about 50. From the above illustration, when the multi-touch is performed, since it is equivalent to multiple touch resistances connected to each other in a parallel connecting mode, the touch resistance value of the multi-touch is less than the touch resistance value of the single-touch. Based on the above experimental data, a preset resistance value corresponding to the multi-touch is determined, and that is, the resistance threshold value of the multi-touch is determined. That is, when the main detecting module 50 detects that the touch resistance value is less than the preset resistance value, it means that multiple touch points are touched on the touch panel 1. Thus, the touch panel 1 is determined to execute the multi-touch mode.

The touch resistance value mentioned above is not measured in ohm, and it only may be considered as the relative value of the resistance. This is because the touch resistance value is obtained by making a multiplication with a constant (namely the V/(Rx1+Rx2) in the formula above).

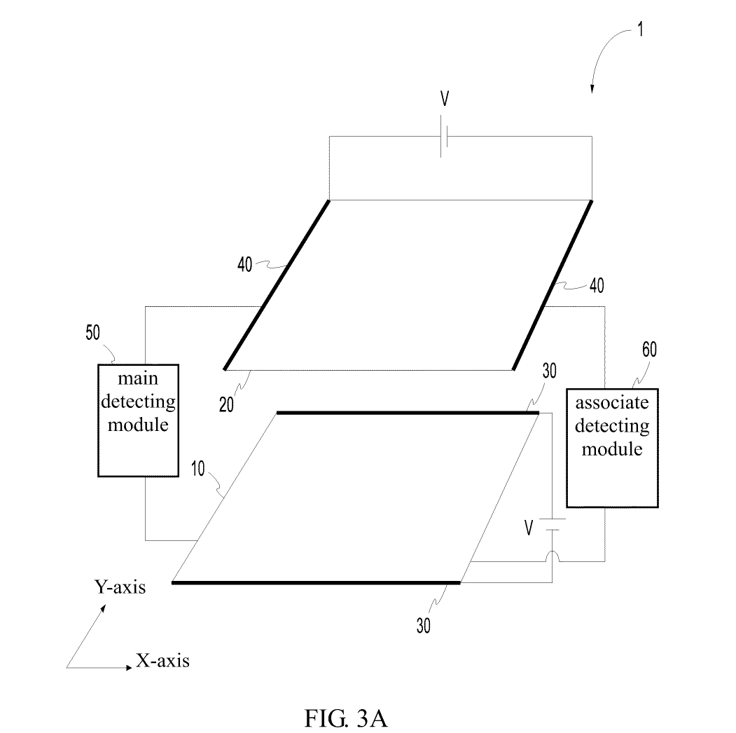

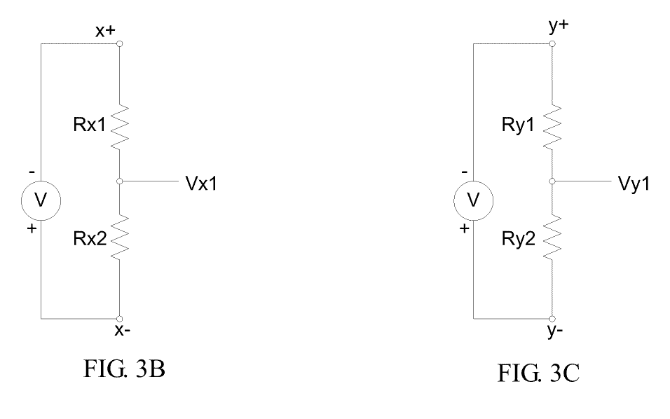

FIG. 3A is a schematic diagram showing the touch panel having the multi-touch function in a second embodiment. As shown in FIG. 3A, to make the touch panel 1 in the invention detect the multi-touch more exactly, in the second embodiment an associate detecting module 60 is further included.

As shown in FIG. 3B, FIG. 3C, FIG. 2A and FIG. 2B, when the touch panel 1 is touched by multiple fingers, as shown in FIG. 2A, the X-axis dividing voltage generated by the first touch point is Vxo, and as shown in FIG. 3B, the X-axis dividing voltage generated by the second touch point is Vx1. The difference value between the Vx0 and the Vx1 is greater than a preset voltage difference value. Similarly, as shown in FIG. 2B, the Y-axis dividing voltage generated by the first touch point is Vy0, and as shown in FIG. 3C, the Y-axis dividing voltage generated by the second touch point is Vy1. The difference value between the Vy0 and the Vy1 is also greater than the preset voltage difference value. Thus, when the user touches the touch panel 1, the associate detecting module 60 detects the corresponding dividing voltages which may be the X-axis voltage and the Y-axis voltage. The multi-touch has a voltage characteristic, which is when the touch points are located at the upper left and the lower right, or the upper right and the lower left, the X-axis voltage or the Y-axis voltage may be changed a lot (namely the illustration for FIG. 3B and FIG. 3C contrasting to the FIG. 2A and FIG. 2B). That is, the voltage difference (ΔV) between the two touch points changes a lot. The farther the two touch points is away from each other, the more obvious the voltage difference is. Thus, using the voltage characteristic, the associate detecting module 60 determines the multi-touch mode is executed when the difference value between the X-axis voltage and the Y-axis voltage generated via the voltage division is greater than the preset voltage difference value. Thus, the associate detecting module 60 helps with the detection of whether the multi-touch mode is executed to improve the accuracy in detecting.

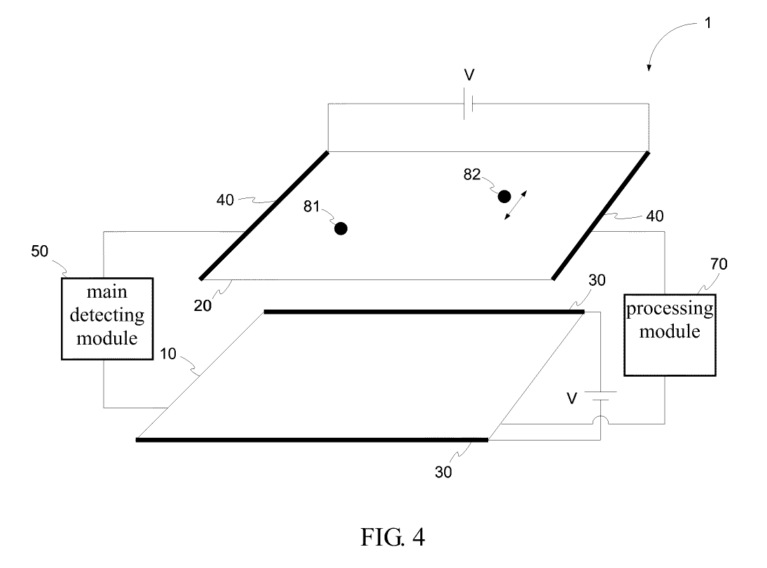

As shown in FIG. 4, it is a schematic diagram showing the touch panel having the multi-touch function in the third embodiment of the invention. In the third embodiment, a processing module 70 is additionally added.

When the touch panel 1 executes the multi-touch mode, it means at least two touch points are generated. Taking the two touch points as an example, when the multi-touch mode is executed, the touch panel 1 includes a first touch point 81 and a second touch point 82. At that moment, the processing module 70 obtains the position change of the second touch point 82, obtains the corresponding key information according to the position change and controls the image displayed by the touch panel 1 according to key information.

The key information records corresponding key definition. That is, it records the corresponding relation of the key information and the key definition of the keyboard or the mouse. Recording the corresponding relation of the key information and the key definition of other input devices may allow the user to use the input functions of other input devices by touching the touch panel 1 directly without inputting operation instructions by other input devices.

After the processing module 70 of the touch panel 1 obtains the position change of the second touch point 82, the corresponding key information is obtained according to the position change, and the key definition is obtained from the key information.

For example, when the user presses the touch panel 1 with two fingers, a first touch point 81 and a second touch point 82 are generated. Supposing that the touch panel 1 displays multiple images at that moment, and the first touch point 81 is on one of the images, and it is also the first point detected by the touch panel 1. The second touch point 82 is the second point detected by the touch panel 1. At that moment, the user may move fingers to change the position of the second touch point 82. As shown in FIG. 4, if the position of the second touch point 82 changes up and down, and that is, the finger moves up and down at the surface of the transparent conductive film 20 of the touch panel 1, the image pointed by the first touch point 81 is zoomed in or zoomed out about the first touch point 81. Thus, the processing module 70 may adjust the display mode of the image about the first touch point 81.

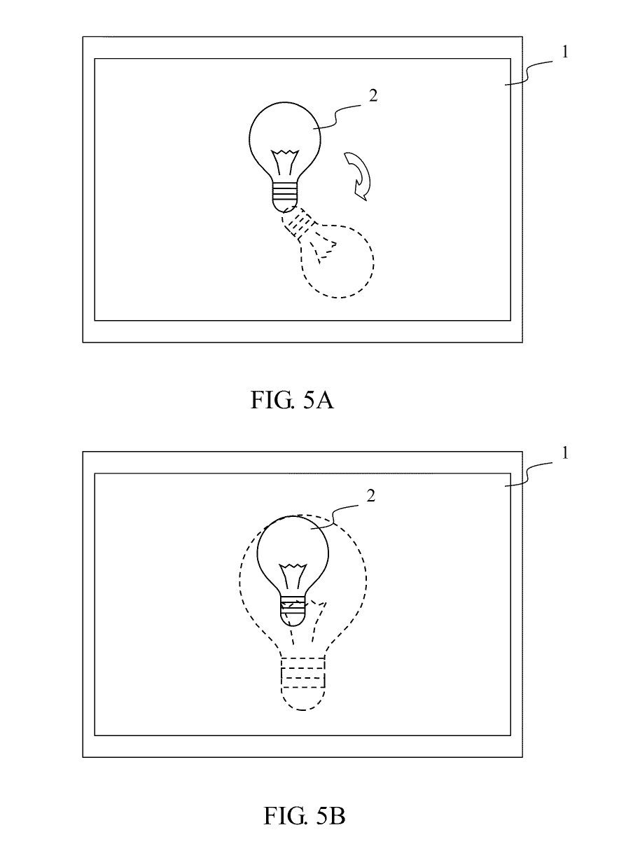

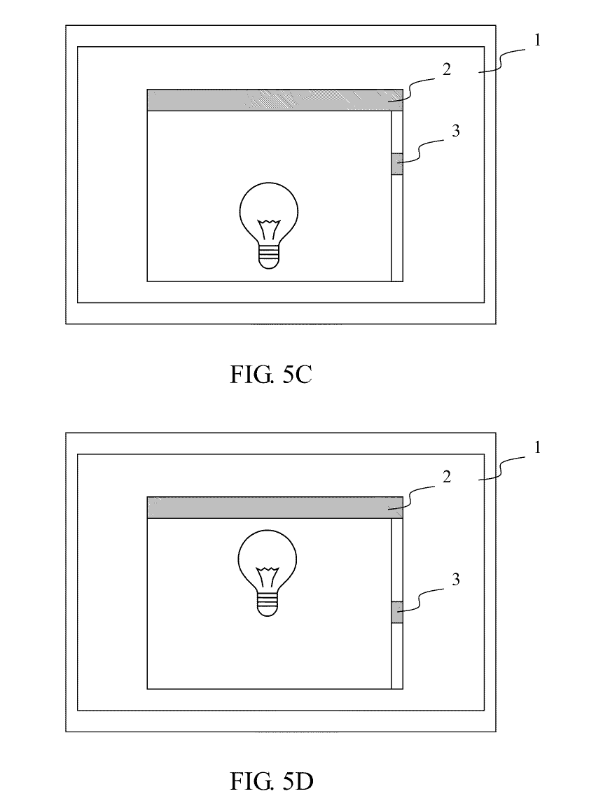

The display mode has multiple examples. As shown in FIG. 5A to FIG. 5D. The display mode may be rotating, zooming in or zooming out. As shown in FIG. 5A and FIG. 5B, the image 2 displayed by the touch panel 1 may be rotated, zoomed in or zoomed out along with the position change of the second touch point. With the cooperation of multiple different position changes of the second touch point, the image 2 displayed by the touch panel 1 may rotate clockwise or anticlockwise, and it also may change in other modes.

In addition, the display mode may be moving the scroll bar to change the display area of the image. As shown in FIG. 5C and FIG. 5D, the image 2 displayed by the touch panel 1 has a scroll bar 3, and the scroll bar 3 of the image 2 may be moved along with the position change of the second touch point to change the display area of the image 2.

In addition, the display mode also may be page turning to change the display area of the image 2. For example, a page up or a page down may be performed to change the display area of the image 2.

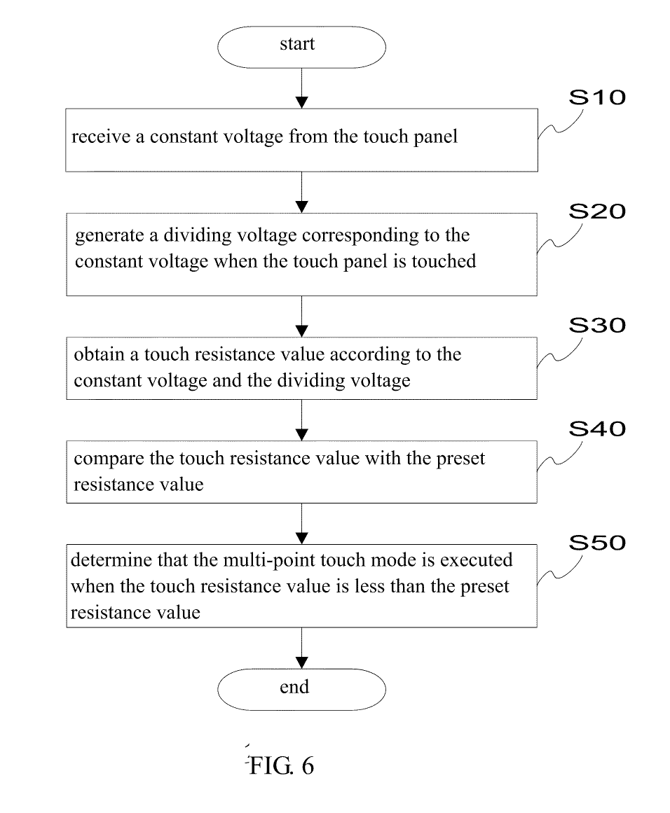

As shown in FIG. 6, it is a flow chart showing the method for detecting the multi-touch used in the touch panel, which includes the steps as follows.

In step S10, the touch panel receives the constant voltage. The touch panel may be a four-wire resistive touch panel.

In step S20, when the touch panel is touched, the dividing voltage corresponding to the constant voltage is generated.

In step S30, the touch resistance value is obtained according to the constant voltage and the dividing voltage.

In step S40, the touch resistance value is compared with the preset resistance value.

In step S50, when the touch resistance value is less than the preset resistance value, it is determined that the touch panel executes the multi-touch mode.

Besides, the invention provides additional assistant detections which may include the steps as follows. When multiple fingers touch the panel, the X-axis voltage and the Y-axis voltage are generated according to the voltage division theorem. When the X-axis voltage difference value between the first and second touch points and the Y-axis voltage difference value between the first and the second touch points are detected to be greater than the preset voltage differential value, it is determined that the multi-touch mode is executed. The above steps may help with the detection, and it makes the multi-touch detection more accurate.

The above multi-touch mode includes a first touch point and a second touch point. When the multi-touch mode is executed, the position change of the second touch point is obtained. According to the position change, the corresponding key information is obtained. Thus, the image displayed by the touch panel is controlled according to the key information. The key information corresponds to the key definition of the keyboard or the mouse.

The above steps may further include adjusting the display mode of the image about the first touch point. The display mode herein may be rotating, zooming in or zooming out, or it may be moving the scroll bar to change the display area of the image or performing the page up or page down to change the display area of the image.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A touch panel having a multi-touch function, comprising:
a transparent conductive substrate;
a transparent conductive film disposed on the transparent conductive substrate;
two first conducting wires disposed at two sides of the transparent conductive substrate, respectively to provide a constant voltage;
two second conducting wires disposed at two sides of the transparent conductive film, respectively, wherein the second conducting wires are vertical to the first conducting wires and used to provide the constant voltage, and when the transparent conductive film is touched, a dividing voltage is generated; and
a main detecting module obtaining a touch resistance value according to the constant voltage and the dividing voltage, comparing the touch resistance value with a preset resistance value and determining that a multi-touch mode is executed when the touch resistance value is less than the preset resistance value.

2. The touch panel having the multi-touch function according to claim 1, further comprising:
a processing module obtaining a position change of a touch point in the multi-touch mode and obtaining key information according to the position change to control an image displayed by the touch panel.

3. The touch panel having the multi-touch function according to claim 2, wherein the key information is a key definition of a keyboard or a mouse.

4. The touch panel having the multi-touch function according to claim 2, wherein the displayed image is one of rotating, zooming in, zooming out, page turning and controlling a scroll bar of the image.

5. A method for detecting a multi-touch used in a touch panel, comprising the steps of:
receiving a constant voltage by the touch panel;
generating a dividing voltage corresponding to the constant voltage;
obtaining a touch resistance value according to the constant voltage and the dividing voltage;
comparing the touch resistance value with a preset resistance value; and
determining that the touch panel executes a multi-touch mode when the touch resistance value is less than the preset resistance value.

6. The method for detecting the multi-touch according to claim 5, further comprising the steps of:
obtaining a position change of a touch point in the multi-touch mode;
obtaining key information according to the position change; and
controlling an image displayed by the touch panel according to the key information.

7. The method for detecting the multi-touch according to claim 6, wherein the key information is a key definition of a keyboard or a mouse.

8. The method for detecting the multi-touch according to claim 6, wherein the displayed image is one of rotating, enlarging, reducing, page turning and controlling a scroll bar of the image.

9. The method for detecting the multi-touch according to claim 5, wherein the touch panel is a four-wire resistive touch panel.
